(19) United States
(12) Patent Application Publication
(10) Pub. No.: US 2010/0260613 A1
(43) Pub. Date: Oct. 14, 2010

(54) Process for preventing the formation of secondary reaction zone in susceptible articles, and articles manufactured using same

(75) Inventors: Alan D. Cetel, West Hartford, CT (US); Shiela R. Woodard, South Windsor, CT (US); Dwayne A. Braithwaite, Wallingford, CT (US); Joseph J. Parkos,, JR., East Haddam, CT (US)

Correspondence Address: BACHMAN & LAPOINTE, P.C. (P&W), 900 CHAPEL STREET, SUITE 1201, NEW HAVEN, CT, 06510-2802, US

(73) Assignee: United Technologies Corporation

(21) Appl. No.: 11/644,627

(22) Filed: Dec. 22, 2006

(51) Int. Cl. F01D 5/14; B05D 3/12; B05D 3/10; C25F 3/16; B32B 15/04

(52) U.S. Cl. 416/241 R; 427/327; 427/309; 205/640; 428/457

(57) ABSTRACT

A process for reducing secondary reaction zone formation articles includes the steps of non-selective removing an external surface of an as-cast article free of coating to form an as-cast article having a surface substantially free of residual surface stress; and applying a coating material upon the surface substantially free of residual surface stress to form a coated as-cast article having a coating layer disposed upon the surface substantially free of residual surface stress.

### FIELD OF THE INVENTION

The invention relates to single crystal superalloys and, more particularly, relates to mitigating the formation of secondary reaction zones in single crystal superalloys with elevated rhenium levels.

### BACKGROUND OF THE INVENTION

Advanced single crystal superalloys are currently being developed. These alloys are characterized by their high levels of rhenium and ruthenium along with high levels of the traditional refractory elements such as tungsten, tantalum and molybdenum. The elevated levels of these elements provide these alloys with exceptional high temperature creep capability. However, the high concentration of these elements also lead to the formation of an undesirable secondary reaction zone (“SRZ”) instability beneath the bondcoat when these single crystal superalloys are coated and exposed for extended periods of time at temperatures at or above approximately 1700° F. (927° C.).

Single crystal superalloys containing high levels of rhenium and other refractory elements are susceptible to SRZ formation beneath the metallic coating or bondcoat after prolonged high temperature exposure. This instability results from the interdiffusion of the aluminum in the coating into the substrate superalloy causing an increased concentration of rhenium and other refractory elements in the gamma matrix. At critical refractory element concentration levels, topologically closed pack (TCP) phases, such as P phase, are nucleated. For example, nickel-based superalloys coated with an aluminide bondcoat experience SRZ formation when exposed for extended periods of time to high temperatures above approximately 1700° F. The SRZ forms in part due to interdiffusion of some constituents, such as Al, between the aluminum-containing, aluminide, PtAl or MCrAlY bondcoat and the nickel-based superalloy. The interdiffusion between the nickel-based superalloy and aluminum containing bondcoat results in the formation of large Ni₃Al precipitates and TCP phases, such as P-phase, near the interface of the alloy and bondcoat diffusion zone. Referring now to a microphotograph in FIG. 1, a typical SRZ that forms at or near the alloy/bondcoat interface is shown. Not only does the SRZ contain phases that can be brittle at temperatures lower than 1700° F. (927° C.), but these phases form have high angle grain boundaries relative to the parent single crystal substrate alloy that are preferential sites for premature crack formation under stressed conditions.

Another factor that promotes the formation of SRZ instability is residual stresses resulting from casting solidification and other post casting processes such as grit blasting and cold working operations. These residual stresses can assist the nucleation of SRZ colonies. The combination of enrichment of refractory elements to critical levels in the substrate adjacent to the coating diffusion zone, particularly rhenium, and elevated local residual stresses, results in SRZ formation after thermal exposure. The TCP phases in the SRZ tie up some of the alloy solid solution strengthening elements (rhenium, tungsten and molybdenum) thereby reducing overall alloy strength and more importantly, the coarse lamellar colonies that form, near the coating alloy diffusion zone, are highly disoriented with respect to the single crystal substrate. The presence of this SRZ instability has been determined to severely debit component durability. Creep and fatigue strength are reduced, as this instability consumes load-bearing area and the high angle boundaries associated with this instability have low strength and ductility and are susceptible to premature crack initiation.

In the past, at least one attempt has been made to mitigate SRZ formation as described in U.S. Pat. Publ. No. 2003/0150901 to Grossman et al. Grossman et al. discloses a method for processing susceptible nickel-base superalloys to minimize the formation of SRZ, in cases where the article would be expected to form SRZ as conventionally processed. The method may also be used to pre-condition articles to minimize SRZ formation after the final aluminide coating is deposited. Grossman et al. discloses depositing upon the nickel-base superalloy an aluminum-containing coating comprising an initial coating additive zone and an initial coating diffusion zone. After the deposition, the coated nickel-base superalloy is heated at a sufficiently high temperature for a sufficiently long period of time, e.g., 2050° F. (1121° C.) for 50 hours or 2000° F. (1093° C.) for 400 hours, to form SRZ. The SRZ, initial coating additive zone and initial coating diffusion zone are then removed to provide a fresh surface that is substantially without cold work and residual stress. The key drawback to the process taught by Grossman et al. is the need to deposit an aluminum containing coating and then stripping the coating which requires additional processing steps resulting in extended lead times and manufacturing cost It also requires exposing the article to high temperatures for long times which can be damaging to the durability of the component.

Therefore, there exists a need to reduce, eliminate or delay SRZ formation in single crystal superalloys to avoid the severe degradation of mechanical properties associated therewith.

### SUMMARY OF THE INVENTION

In accordance with one aspect of the present invention, a process for reducing secondary reaction zone formation in susceptible articles broadly comprises polishing an external surface of an as-cast article free of coating to form an as-cast article having a surface substantially free of residual surface stress; and applying a coating material upon the surface substantially free of residual surface stress to form a coated as-cast article having a coating layer disposed upon the surface substantially free of residual surface stress.

In accordance with another aspect of the present invention, a coated article broadly comprises a single crystal superalloy based article having at least one polished surface substantially free of residual surface stress, and at least one coating disposed upon the at least one polished surface, wherein the single crystal superalloy is free of an intermediate coating disposed between the at least one polished surface and the coating.

The details of one or more embodiments of the invention are set forth in the accompanying drawings and the description provided below. Other features, objects, and advantages of the invention will be apparent from the description and drawings, and from the claims.

### BRIEF DESCRIPTION OF THE DRAWINGS

FIG. 1 is a microphotograph of SRZ formation at a nickel-based superalloy/aluminide coating diffusion zone interface;

FIG. 2 is a flowchart illustrating a non-limiting, exemplary process described herein;

FIG. 3 is a representation of an as-cast article and a layer of material removed from an as-cast surface in accordance with the non-limiting, exemplary process of FIG. 2;

FIG. 4 is a representation of an as-cast article of FIG. 3 coated in accordance with the non-limiting, exemplary process of FIG. 2;

FIG. 5 is a microphotograph of a nickel-based superalloy/PWA 275 aluminide coated sample manufactured according to the non-limiting, exemplary process of FIG. 2;

FIG. 6 is a microphotograph of another nickel-based superalloy/PWA 275 aluminide coated sample manufactured according to the non-limiting, exemplary process of FIG. 2;

FIG. 7 is a microphotograph of a nickel-based superalloy/PWA 275 aluminide coated sample manufactured according to a process of the prior art; and

FIG. 8 is a microphotograph of another nickel-based superalloy/PWA 275 coated sample manufactured according to a process of the prior art.

Like reference numbers and designations in the various drawings indicate like elements.

### DETAILED DESCRIPTION

A process for reducing SRZ formation in susceptible single crystal superalloys is described herein. Generally, the process involves removing a finite surface layer of material by polishing, or other low stress chemical or electrochemical operations, to achieve a surface of an as-cast article free of coating to form an as-cast article having a surface substantially free of residual surface stress and with reduced near surface chemical segregation. A stress relief heat treatment is applied prior to the application of the coating or bondcoat to insure that surface residual stresses are minimized before application of the coating or bondcoat. The stress relief heat treatment generally involves exposure of the article to temperatures between 2000° F. (1093° C.) and 2100° F. (1149° C.) for periods ranging between 1 and 4 hours. A coating or bondcoat material may then be applied to the surface substantially free of residual stress to form a coated as-cast article having a coating or bondcoat disposed upon the surface substantially free of residual stress.

It has been discovered that removing a finite layer of material from the as-cast surface of a single crystal nickel-based superalloy article prevents or retards SRZ formation at the interface between the single crystal superalloy and the coating or bondcoat diffusion zone of the coated as-cast article. The removal of this surface layer of material reduces both the chemical driving force behind nucleation and the strain energy available to assist nucleation.

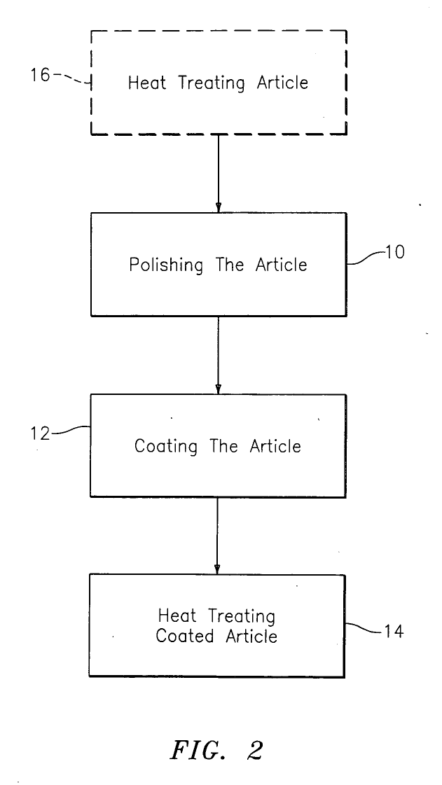

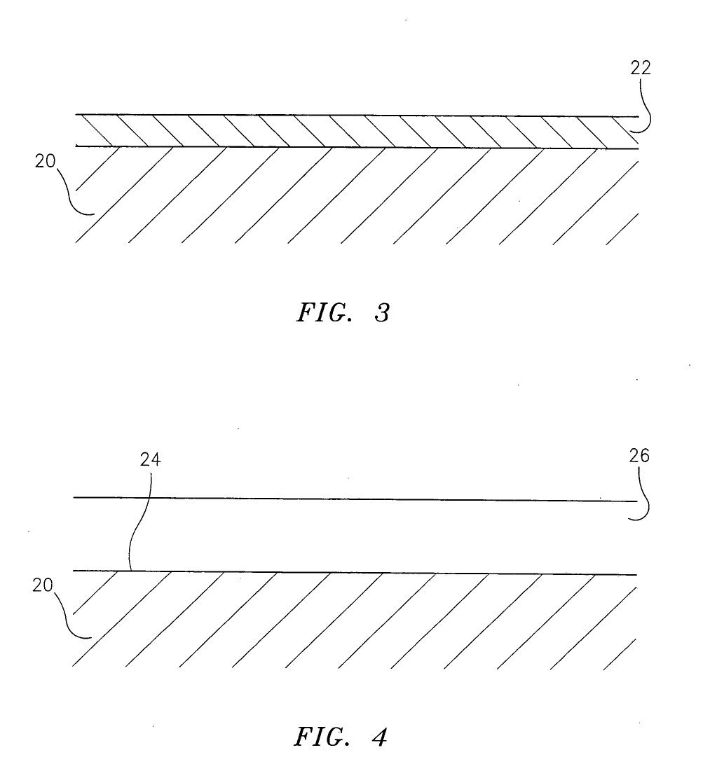

Referring now to FIGS. 2-4, a flowchart illustrating the process of the present invention is shown. An article with an as-cast surface 20 may be polished to remove a layer of material 22 at step 10. The amount of material removed may be dependent upon several factors such as the type of single crystal superalloy, the original thickness of the article, the intended use of the article, and the like, and may be determined by the manufacturer. For example, when manufacturing a turbine blade for a gas turbine engine, the amount of material removed, e.g., the layer of material 22, may represent a thickness of up to 5 mils (127 μm), e.g., about 0.4 (10 μm) to about 3.0 mils (75 μm).

Any one of a number of non-selective material removal processes may be used to remove the layer of material 22 as known to one of ordinary skill in the art. As used herein, the term “non-selective material removal process” means a process that does not result in certain microstructural phases being selectively attacked leading to uneven, non-uniform metal removal. In contrast, the opposite of non-selective material removal would be a process that leads to a pitting condition, which occurs where more material has been removed in contrast to the remainder of the surface. In addition, non-selectively removing a finite layer of material from the as-cast surface of an article may also be referred to as polishing as described herein. For example, polishing processes may include any one of the following methods: mechanical polishing, chemical milling, electrochemical milling, electrochemical polishing (“electropolishing”), chemical stripping, combinations thereof, and the like. Mechanical polishing may involve polishing the surface of the single crystal superalloy based article using a polishing wheel or an abrasive paste as known to one of ordinary skill in the art. When performing chemical milling, electropolishing, or electrochemical milling processes as known to one of ordinary skill in the art, all of these processes may involve using any one of the following solutions, but not limited to: sulfuric acid based, phosphoric acid based, nitric acid with ferrous chloride, nitric acid with ferric chloride, hydrochloric acid with ferrous chloride, hydrochloric acid with ferric chloride, hydrogen fluoride with ferrous chloride, hydrogen fluoride with ferric chloride, phosphoric acid with ferrous chloride, phosphoric acid with ferric chloride, phosphoric acid with sulfuric acid, phosphoric acid with sulfuric acid and glycerin, combinations thereof, and the like. In carrying out each process, the process may be performed in order to polish, and in turn non-selectively remove, an amount of single crystal superalloy sufficient to reduce both the chemical driving force behind nucleation and the strain energy available to assist nucleation. Each of these processes may be conducted at conditions that vary with chemical composition, desired effect, and current density employed in electrochemical processes. This process may be applied to a range of components utilized in gas turbine engines including turbine blades and vanes and blade outer airseals (BOAS).

After polishing to remove the surface layer of material 22, a coating material may be deposited upon the exposed surface 24 of the single crystal superalloy based article 20 to form a coating layer 26. The coating material may comprise an aluminide or PtAl aluminide coating or an MCrAlY type coating. MCrAlY refers to known metal coating systems in which M denotes nickel, cobalt, iron, their alloys, and mixtures thereof; Cr denotes chromium; Al denotes aluminum; and Y denotes yttrium. MCrAlY materials are often known as overlay coatings because they are applied in a predetermined composition and do not interact significantly with the substrate during the deposition process. For some non-limiting examples of MCrAlY materials see U.S. Pat. No. 3,528,861 which describes a FeCrAlY coating as does U.S. Pat. No. 3,542,530. In addition, U.S. Pat. No. 3,649,225 describes a composite coating in which a layer of chromium is applied to a substrate prior to the deposition of a MCrAlY coating. U.S. Pat. No. 3,676,085 describes a CoCrAlY overlay coating while U.S. Pat. No. 3,754,903 describes a NiCoCrAlY overlay coating having particularly high ductility. U.S. Pat. No. 4,078,922 describes a cobalt base structural alloy which derives improved oxidation resistance by virtue of the presence of a combination of hafnium and yttrium. A preferred MCrAlY composition is described in U.S. Pat. No. Re. 32,121, which is assigned to the present Assignee and incorporated herein by reference, as having a weight percent compositional range of 5-40 Cr, 8-35 Al, 0.1-2.0 Y, 0.1-7 Si, 0.1-2.0 Hf, balance selected from the group consisting of Ni, Co and mixtures thereof. See also U.S. Pat. No. 4,585,481, which is also assigned to the present Assignee and incorporated herein by reference.

The coating material may also comprise Al containing aluminide, PtAl and the like, that are often known in the art as diffusion coatings. In addition, the coating material may also comprise Al containing or PtAl containing MCrAlY coating materials as described above, and the like, that are often known in the art as LPPS (low pressure plasma spray), HVOF (high velocity) or cathodic arc applied coatings.

The coating layer 26 may be applied by any method capable of producing a dense, uniform, adherent metallic coating of the desired composition, such as, but not limited to, an overlay, diffusion, low pressure plasma spray, cathodic arc, and the like. Such techniques may include, but are not limited to, diffusion processes (e.g., inward, outward, etc.), low pressure plasma-spray, air plasma-spray, sputtering, cathodic arc, electron beam physical vapor deposition, high velocity plasma spray techniques (e.g., HVOF, HVAF), combustion processes, wire spray techniques, laser beam cladding, electron beam cladding, etc.

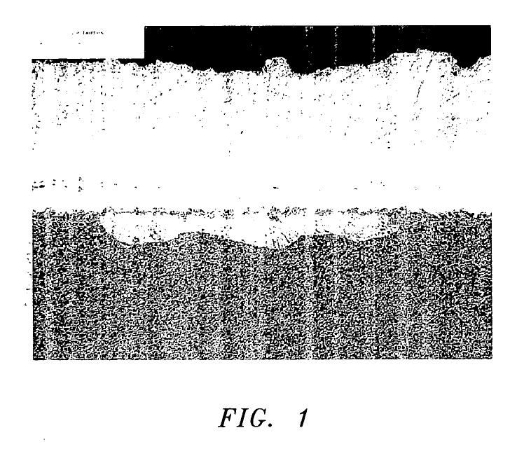

After applying the coating layer 26, the coated single crystal superalloy based article may be heat treated at step 14 of FIG. 1. This heat treatment is employed to create the aluminide or PtAl coating and for an MCrAlY coating to help form a metallurgical bond between the substrate and coating by producing a diffusion zone between the alloy and coating. Generally, the heat treatment step may be performed using, e.g., a heat treatment furnace as known to one of ordinary skill in the art. The coated single crystal superalloy article may be heat treated at a temperature of about 1975° F. (1079° C.) to about 2050° F. (1121° C.) for a period of time of about 1 hour to about 16 hours.

Experimental Results

Four samples were prepared. Each sample consisted of an as-cast bar of a single crystal alloy (“Alloy A”) composed of 2Cr, 6W, 2Mo, 6Re, 3Ru, 5.65Al, 16.5Co, 8Ta, 0.15Hf, with the remainder being Ni, commercially available from United Technologies Corporation, Hartford, Conn., that measured 4.0 in.×0.5 in.×0.5 in. Each as-cast bar had a coating of PWA 275 The PWA 275 coating contains Al at a nominal level of about 27% and has a thickness of 2.0 mils (51 micrometers). Each sample 1-4 was prepared in accordance with the steps shown in Table 1. Samples 1-4 were then aged at a temperature of 1800° F. for period of 100 hours prior to determining the approximate amount of SRZ formation in each sample.

TABLE 1

| | | | | PWA | | | |
|---|---|---|---|---|---|---|---|
| | | | | 275 | | | SRZ |
| Sample | SHT¹ | Polish | SRHT² | Coat | DHT³ | PHT⁴ | Formation |
| Sample 1 | 2400° F. | Electropolish with | — | 2050° F. | 1975° F. | 1700° F. | Approx. |
| | @ 6 hrs | Phosphoric/Sulfuric | | @ 5.5 hrs | @ 4 hrs | @ 12 hrs | 5% |
| | | Acids | | | | | |
| Sample 2 | 2400° F. | Electropolish with | 2050° F. | 2050° F. | 1975° F. | 1700° F. | Approx. |
| | @ 6 hrs | Phosphoric/Sulfuric | @ 4 hrs | @ 5.5 hrs | @ 4 hrs | @ 12 hrs | 0% |
| | | Acids | | | | | |
| Sample 3 | 2400° F. | — | — | 2050° F. | 1975° F. | 1700° F. | Approx. |
| | @ 6 hrs | | | @ 5.5 hrs | @ 4 hrs | @ 12 hrs | 75% |
| Sample 4 | 2400° F. | — | 2050° F. | 2050° F. | 1975° F. | 1700° F. | Approx. |
| | @ 6 hrs | | @ 4 hrs | @ 5.5 hrs | @ 4 hrs | @ 12 hrs | 10% |

¹(SHT) solution heat treatment
²(SRHT) stress relief heat treatment
³(DHT) diffusion heat treatment
⁴(PHT) precipitation heat treatment

Sample 1 exhibited an approximate SRZ circumferential coverage of 5%. Sample 2 exhibited 0% SRZ coverage. Sample 3 exhibited an approximate SRZ coverage of 75%. Sample 4 exhibited an approximate SRZ coverage of 10%.

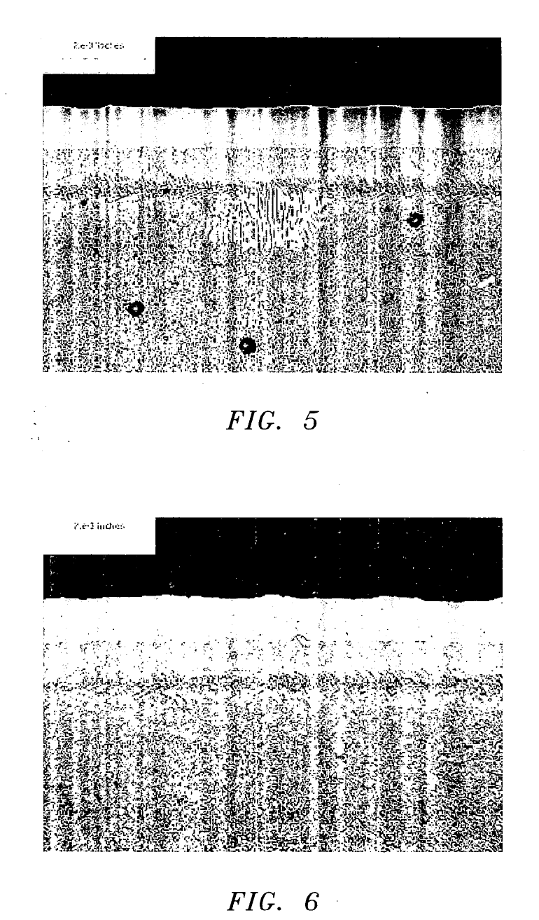

Sample 1 of the microphotograph of FIG. 5 exhibited a minor amount of SRZ formation at the alloy A surface/PWA 275 coating diffusion zone interface. Sample 1 underwent surface removal through electrochemical polishing but did not receive additional stress relief heat treatment prior to coating. The lack of the additional stress relief heat treatment allowed surface residual stresses from the casting and post casting processing operations to remain in the test piece. It is believed the minor SRZ formation observed after coating and exposure is attributable to not performing this step.

Sample 2 of the microphotograph of FIG. 6 exhibited virtually no SRZ formation at the alloy A surface/PWA 275 coating diffusion zone interface. Sample 2 underwent both surface removal processing through electrochemical polishing and the additional stress relief heat treatment to further relieve any residual surface stresses from the casting and processing operations prior to coating. It is believed performing both these operations contributed to the absence of SRZ formation after coating and thermal exposure.

Sample 3 of the microphotograph of FIG. 7 exhibited the greatest amount of SRZ formation at the alloy A surface/PWA 275 coating diffusion zone interface. Sample 3 did not undergo surface removal processing through electrochemical polishing and was not subjected to an additional stress relief heat treatment. These factors are believed to have contributed to the significant SRZ formation after coating and thermal exposure.

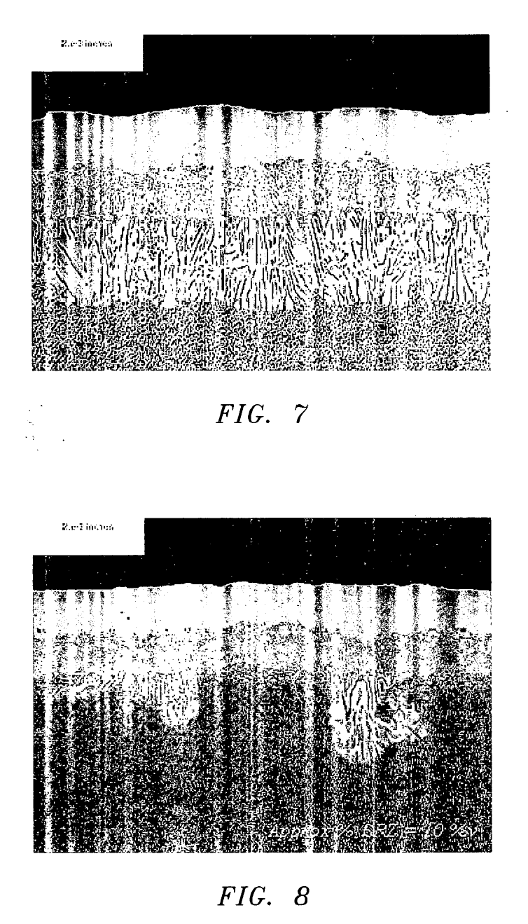

Sample 4 of the microphotograph of FIG. 8 exhibited a minor amount of SRZ formation at the alloy A surface/PWA 275 coating diffusion zone interface. Sample 4 underwent the additional stress relief heat treatment but did not undergo surface removal processing through electrochemical polishing. The additional stress relief heat treatment step reduced some residual surface stresses but not enough to prevent SRZ formation after coating and thermal exposure.

These results indicate coated alloy A superalloy samples that underwent both surface removal through electrochemical polishing and stress relief heat treatment exhibited virtually no SRZ formation. Samples that underwent surface removal through electrochemical polishing exhibited less SRZ formation than samples that were not polished. Samples that at least underwent stress relief heat treatment without polishing exhibited less SRZ formation than samples which did not receive either polishing or stress relief heat treatment.

One or more embodiments of the present invention have been described. Nevertheless, it will be understood that various modifications may be made without departing from the spirit and scope of the invention. For example, it is contemplated that after performing the SRZ mitigation processes of the present invention, additional processes such as carburizing, nitriding, and the like may also be performed to further mitigate, if necessary, SRZ formation. Accordingly, other embodiments are within the scope of the following claims.

1. A process for reducing secondary reaction zone formation, comprising:
polishing an external surface of an as-cast article free of coating to form an as-cast article having a surface substantially free of residual surface stress; and
applying a coating material upon said surface substantially free of residual surface stress to form a coated as-cast article having a coating layer disposed upon said surface substantially free of residual surface stress.

2. The process of claim 1, wherein polishing comprises removing a layer of material from at least said portion of said external surface of said as-cast article free of coating.

3. The process of claim 2, wherein polishing comprises removing a layer of material having a thickness of about 0.4 mils (10 micrometers) to about 5.0 mils (127 micrometers).

4. The process of claim 1, wherein polishing comprises any one of the following processes: mechanical polishing, chemical milling, electropolishing, electrochemical milling, chemical stripping, and combinations thereof.

5. The process of claim 4, wherein mechanical polishing comprises polishing said surface using a polishing wheel.

6. The process of claim 4, wherein mechanical polishing comprises polishing said surface using an abrasive paste.

7. The process of claim 4, wherein chemical milling comprises chemically milling said surface using any one of the following solutions: sulfuric acid based, phosphoric acid based, nitric acid with ferrous chloride, nitric acid with ferric chloride, hydrochloric acid with ferrous chloride, hydrochloric acid with ferric chloride, hydrogen fluoride with ferrous chloride, hydrogen fluoride with ferric chloride, phosphoric acid with ferrous chloride, phosphoric acid with ferric chloride, phosphorus acid with sulfuric acid, and phosphoric acid with sulfuric acid and glycerin.

8. The process of claim 4, wherein electrochemical milling comprises electrochemically milling said surface using any one of the following solutions: sulfuric acid based, phosphoric acid based, nitric acid with ferrous chloride, nitric acid with ferric chloride, hydrochloric acid with ferrous chloride, hydrochloric acid with ferric chloride, hydrogen fluoride with ferrous chloride, hydrogen fluoride with ferric chloride, phosphoric acid with ferrous chloride, and phosphoric acid with ferric chloride, phosphorus acid with sulfuric acid, and phosphoric acid with sulfuric acid and glycerin.

9. The process of claim 4, wherein said electropolishing comprises electrochemically milling said surface using any one of the following solutions: sulfuric acid based, phosphoric acid based, nitric acid with ferrous chloride, nitric acid with ferric chloride, hydrochloric acid with ferrous chloride, hydrochloric acid with ferric chloride, hydrogen fluoride with ferrous chloride, hydrogen fluoride with ferric chloride, phosphoric acid with ferrous chloride, and phosphoric acid with ferric chloride, phosphorus acid with sulfuric acid, and phosphoric acid with sulfuric acid and glycerin.

10. The process of claim 4, wherein chemical stripping comprises chemically stripping said surface using a chemical acid solution.

11. The process of claim 1, further comprising heat treating said as-cast article free of coating at a temperature of about 2350° F. (1288° C.) to about 2450° F. (1343° C.) for a period of time of about 0.5 hours to about 10 hours prior to non-selectively removing said external surface.

12. The process of claim 1, further comprising stress relief heat treating said as-cast article at a temperature of about 2000° F. (1093° C.) to about 2100° F. (1149° C.) for a period of time of about 1 hour to about 4 hours prior to applying said coating material.

13. A coated article, comprising:
a single crystal superalloy based article having at least one polished surface substantially free of residual surface stress, and at least one coating disposed upon said at least one polished surface,
wherein said single crystal superalloy is free of an intermediate coating disposed between said at least one polished surface and said coating.

14. The coated article of claim 13, wherein said single crystal superalloy based article comprises a nickel alloy.

15. The coated article of claim 13, wherein said article comprises a gas turbine engine component.

16. The coated article of claim 15, wherein said gas turbine engine component is a turbine engine blade, a vane, or a blade outer airseal component.

17. The coated article of claim 13, wherein said polished surface comprises a removed layer of material having a thickness of about 0.4 mils to about 3.0 mils.
